(19) United States
(12) Patent Application Publication
(10) Pub. No.: US 2011/0037654 A1
(43) Pub. Date: Feb. 17, 2011

(54) Dual-frequency antenna

(76) Inventors: Chih-Hsin Chiu, Ji-an Township (TW); Chung-Ta Yu, Keelung City (TW); Chun-Chieh Wang, Taipei City (TW); Chih-Ming Su, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/461,391

(22) Filed: Aug. 11, 2009

(51) Int. Cl. H01Q 5/00; H01Q 1/38

(52) U.S. Cl. 343/700 MS

(57) ABSTRACT

A dual-frequency antenna includes a substrate, a ground plane, a radiation path, a short-circuit path and a connection path. The ground plane is disposed on the substrate and has a short-circuit point and a ground point. The radiation path is disposed on the substrate, adjacent to the ground plane. A feed point is disposed on one end of the radiation path, corresponding to the ground point; and a first connecting point is formed on the radiation path. A short-circuit path is disposed on the substrate, two ends of the short-circuit path respectively electrically connected with the short-circuit point and the feed point, and a second connecting point is formed on the short-circuit path. The connection path is disposed on the substrate, two ends of the connection path respectively electrically connected with the first connecting point and the second connecting point.

### BACKGROUND OF THE INVENTION

1. Field of the Invention

The present invention relates to a dual-frequency antenna, and more particularly to a dual-frequency antenna which can adjust antenna resonant frequency bands.

2. Description of Related Art

With the development of wireless communication technologies, wireless transmission technologies are widely used in mobile information media or personal data management tools. For example, electronic products, such as notebook computers and so on, usually need to transmit/receive data to/from other data devices. Based on wireless transmission technologies, many structures can be simplifies and many connecting wires can be avoided.

To achieve the above-mentioned wireless transmission, conventional electronic products must have antennae, and most of the electronic products have inbuilt antenna devices for wireless communication. Antennae of conventional electronic products are generally divided into two categories as planar and inverse F-shaped panel antennae and monopole antennae. With the miniaturization development of electronic products, antennae need to be smaller and smaller. However, because frequency bandwidth, gain values and radiation efficiencies of planar and inverse F-shaped panel antennae are proportional to the volume of the antennae, the planar and miniaturized design for antennae causes that their frequency bandwidth and radiation efficiencies are reduced greatly. So dual-frequency antenna devices formed by planar and inverse F-shaped panel antennae usually have narrow frequency bands, which cannot covers the 5.2˜5.8 GHz work frequency range under IEEE802.11a and the 2.4˜2.5 GHz work frequency range under IEEE802.11b simultaneously. Though monopole antennae have wide frequency bands, they must have large ground portions during use, which limits limited using space of electronic products such as notebook computers.

In other words, though there have been antenna devices which can work in dual frequency bands, relationships between elements of the antenna devices must be considered when operation frequency bands of the antenna devices are adjusted, which causes that the antenna devices have complicated structures. Furthermore, with the miniaturization development of wireless electronic products, antennae must be limited in a certain volume to meet the requirements of the electronic products. Accordingly, how to design smaller, lighter and stabler antennae is a problem desired to be solved in wireless technology fields.

Hence, the inventors of the present invention believe that the shortcomings described above are able to be improved and finally suggest the present invention which is of a reasonable design and is an effective improvement based on deep research and thought.

### SUMMARY OF THE INVENTION

A main object of the present invention is to provide a dual-frequency antenna which can work in dual frequency bands and adjust frequency of a resonant mode of the antenna to excite the desired frequency band.

Another object of the present invention is to provide a dual-frequency antenna which has a planarization design and can reduce the volume and size effectively to meet the miniaturization requirement of wireless communication systems and devices.

To achieve the above-mentioned objects, a dual-frequency antenna in accordance with the present invention is provided. The dual-frequency antenna includes a substrate; a ground plane which is disposed on the substrate and has a short-circuit point and a ground point; a radiation path disposed on the substrate and adjacent to the ground plane, wherein a feed point is disposed on one end of the radiation path, corresponding to the ground point, and a first connecting point is formed on the radiation path; a short-circuit path disposed on the substrate, wherein two ends of the short-circuit path are respectively electrically connected with the short-circuit point and the feed point, and a second connecting point is formed on the short-circuit path; and a connection path disposed on the substrate, wherein two ends of the connection path are respectively electrically connected with the first connecting point and the second connecting point.

Based on the above-mentioned structure, the dual-frequency antenna of the present invention can be applied in dual-frequency applications and can be integrated with system circuits to meet the integration and miniaturization requirements of electronic products.

To further understand features and technical contents of the present invention, please refer to the following detailed description and drawings related the present invention. However, the drawings are only to be used as references and explanations, not to limit the present invention.

### BRIEF DESCRIPTION OF THE DRAWINGS

FIG. 1 is a schematic view of a dual-frequency antenna of a first embodiment of the present invention;

FIG. 2 is a schematic view of a dual-frequency antenna of a second embodiment of the present invention;

FIG. 3 is a schematic view of a dual-frequency antenna of a third embodiment of the present invention;

FIG. 4 is a S11 graph of the dual-frequency antenna of the second embodiment of the present invention applied in a wireless local area Network;

FIG. 5 is a Smith Chart of the dual-frequency antenna of the second embodiment of the present invention operated at 2.4 GHz; and

FIG. 6 is a Smith Chart of the dual-frequency antenna of the second embodiment of the present invention operated at 5 GHz.

### DETAILED DESCRIPTION OF THE PREFERRED EMBODIMENTS

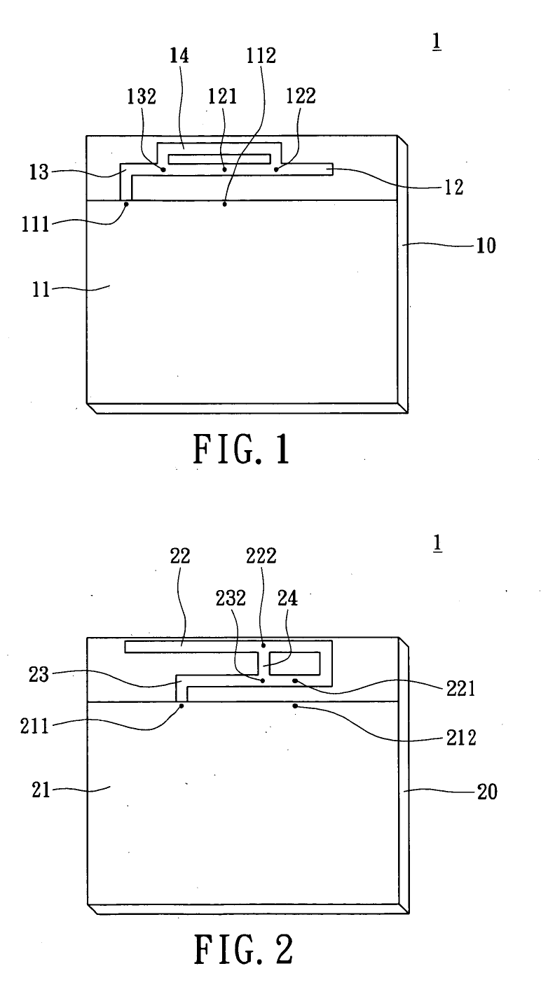

Firstly, please refer to FIG. 1 illustrating a dual-frequency antenna 1 according to the present invention which can excite resonant frequency bands based on the adjustment of the structure, the path and the width of the antenna so as to adjust desired frequency band range and electrical characteristics and can achieve dual-frequency operation in a short-circuit way. The dual-frequency antenna 1 includes a substrate 10, a ground plane 11, a radiation path 12, a short-circuit path 13 and a connection path 14. The substrate 10 is used for carrying the ground plane 11, the radiation path 12, a short-circuit path 13 and the connection path 14; in other words, the antenna structures, such as the ground plane 11, are all disposed on the substrate 10. The substrate 10 is a kind of solid substrate, such as a ceramic substrate, a glassfiber substrate and so on; alternatively, the substrate 10 is an air substrate.

The ground plane 11 is disposed on the substrate 10, and the ground plane 11 has a short-circuit point 111 and a ground point 112. The radiation path 12 is disposed on the substrate 10, adjacent to the ground plane 11. A feed point 121 is disposed on one end of the radiation path 12, corresponding to the ground point 112, and the radiation path 12 further has a first connecting point 122 formed thereon. The two ends of the short-circuit path 13 are respectively electrically connected with the short-circuit point 111 and the feed point 121, and the short-circuit path further has a second connecting point 132 formed thereon. The two ends of the connection path 14 are respectively electrically connected with the first connecting point 122 and the second connecting point 132.

Please refer to FIG. 1 illustrating a first embodiment of the present invention. The ground plane 11 is a metal sheet disposed on the substrate 10, the short-circuit point 111 and the ground point 112 are located on one side of the metal sheet above which the radiation path 12 is located, adjacent to the ground plane 11. The radiation path 12 is formed by a metal sheet without a bend, the feed point 121 is one end point located on the metal sheet, and the first connecting point 122 may be selectively located on one position of the radiation path 12 according to actual application.

Furthermore, the short-circuit path 13 is formed by a metal sheet with one bend, for example, an L-shaped metal sheet. The two ends of the metallic short-circuit path 13 are respectively electrically connected with the short-circuit point 111 and the feed point 121. In other words, the two ends of the short-circuit path 13 are respectively connected with the radiation path 12 and the ground plane 11. The second connecting point 132 may be selectively located on one position of the short-circuit path 13 according to actual application.

The connection path 14 is formed by a metal sheet with two bends. In the embodiment, the connection path 14 is formed by an inverse U-shaped metal sheet, and the two ends of the inverse U-shaped connection path 14 are respectively electrically connected with the first connecting point 122 and the second connecting point 132.

Based on the above structure, the radiation path 12 and the short-circuit path 13 form a resonant path for producing a first operation frequency band and a second operation frequency band of the dual-frequency antenna 1. The connection path 14 is used for adjusting a frequency ratio of the first operation frequency band and the second operation frequency band. To adjust the length (20-50 millimeters) and the width (0.5-5 millimeters) of the radiation path 12 and the short-circuit path 13, the positions of the first connecting point 122 and the second connecting point 132, or the length (1-15 millimeters) and the width (0.5-5 millimeters) of the connection path 14 is to control the first operation frequency band, the second operation frequency band and the ratio of the two frequency bands, thereby achieving dual-frequency band operation. Furthermore, the dual-frequency antenna 1 has a good impedance match.

Please refer to FIG. 2 illustrating a second embodiment of the present invention. The ground plane 21 is a metal sheet disposed on the substrate 20, the short-circuit point 211 and the ground point 212 are located on one side of the metal sheet above which the radiation path 22 is located, adjacent to the ground plane 21. The radiation path 22 is formed by a metal sheet with two bends, the feed point 221 is one end point located on the metal sheet, and the first connecting point 222 may be selectively located on one position of the radiation path 22 according to actual applications. In the embodiment, the radiation path 22 has a similar L-shaped structure, and one end of the radiation path 22 is extended parallel to one side of the ground plane 21, then bent towards the ground plane 21 and extended to form the short edge of the similar L-shaped structure. The free end of the short edge is bent and extended to form the above feed point 221, and the first connecting point 222 is located on the long edge of the similar L-shaped structure.

Furthermore, the short-circuit path 23 is formed by a metal sheet with one bend, for example, an L-shaped metal sheet. The two ends of the metallic short-circuit path 23 are respectively electrically connected with the short-circuit point 211 and the feed point 221. In other words, the two ends of the short-circuit path 23 are respectively connected with the radiation path 22 and the ground plane 21. The second connecting point 232 may be selectively located on one position of the short-circuit path 23 according to actual application.

The connection path 24 is formed by a metal sheet without a bend. In the embodiment, the connection path 24 is a short metal sheet, and the two ends of the connection path 24 are respectively electrically connected with the first connecting point 222 and the second connecting point 232.

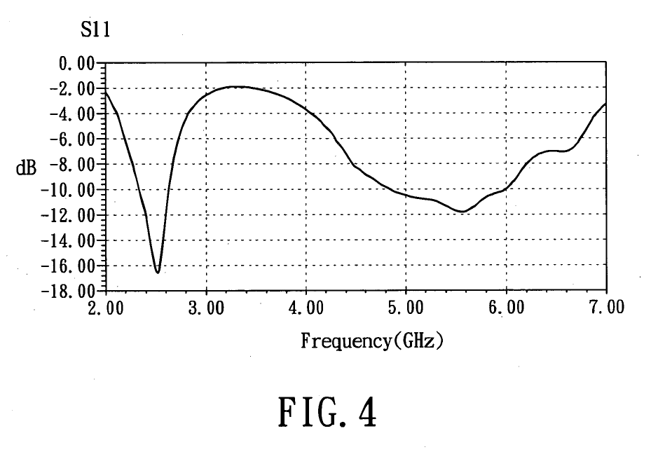

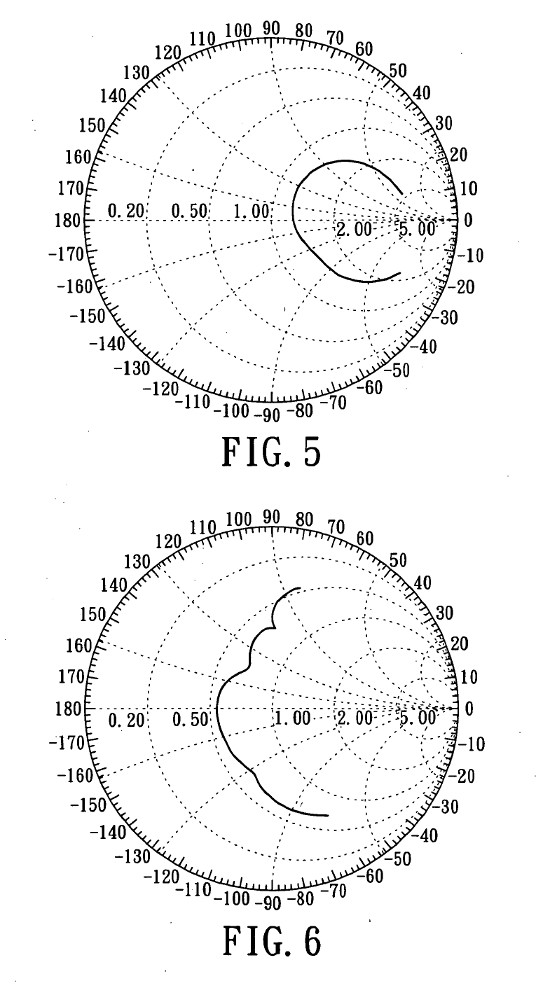

On the other hand, the second embodiment has the same sizes and width conditions with the first embodiment, so it is omitted herein. Please refer to FIG. 4 illustrating a S11 graph of the dual-frequency antenna 1 of the second embodiment applied in a wireless local area Network; FIG. 5 is a Smith Chart of the dual-frequency antenna 1 of the second embodiment operated at 2.4 GHz; and FIG. 6 is a Smith Chart of the dual-frequency antenna 1 of the second embodiment operated at 5 GHz. From the results, the dual-frequency antenna 1 of the present invention has good antenna characteristics.

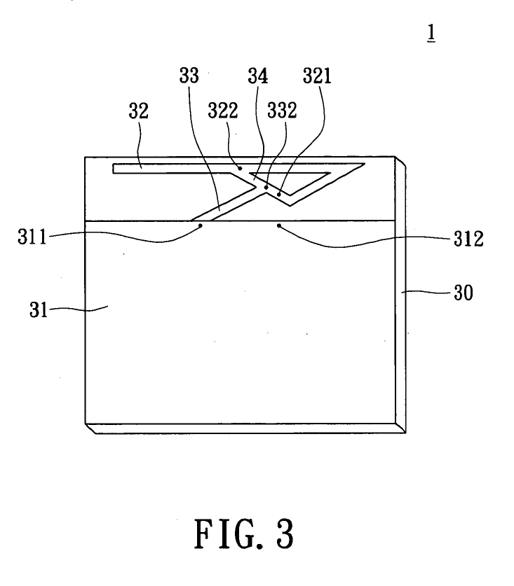

Please refer to FIG. 3 illustrating a third embodiment of the present invention. The ground plane 31 is a metal sheet disposed on the substrate 30, the short-circuit point 311 and the ground point 312 are located on one side of the metal sheet above which the radiation path 32 is located, adjacent to the ground plane 31. The radiation path 32 is formed by a metal sheet with two bends, the feed point 321 is one end point located on the metal sheet, and the first connecting point 322 may be selectively located on one position of the radiation path 32 according to actual application. In the embodiment, one end of the radiation path 32 is extended parallel to one side of the ground plane 31, then bent inclinedly to form an acute angle and extended for a length, and further, the free end is bent inclinedly and extended to form the above feed point 321, and the first connecting point 322 is located on the structure of the radiation path 32 on the side of the metal sheet.

Furthermore, the short-circuit path 33 is formed by a metal sheet with one bend, for example, an L-shaped metal sheet. The two ends of the metallic short-circuit path 33 are respectively electrically connected with the short-circuit point 311 and the feed point 321. In other words, the two ends of the short-circuit path 33 are respectively connected with the radiation path 32 and the ground plane 31. The second connecting point 332 may be selectively located on one position of the short-circuit path 33 according to actual application. In the embodiment, the short-circuit path 33 is formed by extending inclinedly the short-circuit point 311, and then bent and connected with the feed point 321, wherein the bent portion is the second connecting point 332.

The connection path 34 is formed by a metal sheet without a bend. In the embodiment, the connection path 34 is a short metal sheet, and the two ends of the connection path 34 are respectively electrically connected with the first connecting point 322 and the second connecting point 332. Further, the connection path 34 is disposed inclinedly between the radiation path 32 and the short-circuit path 33. Other conditions are the same with those of the first embodiment and the second embedment, so they are omitted herein.

Consequently, the dual-frequency antenna of the present invention has the beneficial effects as follows:

1. The present invention can excite resonant frequency bands based on the adjustment of the structure, the path and the width of the antenna and control the frequency range ratio of the dual frequency bands based on the short-circuit characteristics of the connection path, so that the antenna of the present invention can work in the desired dual-frequency band range.

2. The dual-frequency antenna of the present invention has the advantages of planarization and small size, so it can be applied in micro-communication systems.

What are disclosed above are only the specification and the drawings of the preferred embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A dual-frequency antenna, comprising:
a substrate;
a ground plane, disposed on the substrate and having a short-circuit point and a ground point;
a radiation path disposed on the substrate and adjacent to the ground plane, the radiation path having a feed point disposed on one end thereof, the feed point corresponding to the ground point, and the radiation path having a first connecting point formed thereon;
a short-circuit path disposed on the substrate, two ends of the short-circuit path respectively electrically connected with the short-circuit point and the feed point, and the short-circuit path having a second connecting point formed thereon; and
a connection path disposed on the substrate, two ends of the connection path respectively electrically connected with the first connecting point and the second connecting point.

2. The dual-frequency antenna as claimed in claim 1, wherein the ground plane is a metal sheet, and the short-circuit point and the ground point are located on one side of the metal sheet above which the radiation path is located.

3. The dual-frequency antenna as claimed in claim 2, wherein the radiation path is a metal sheet without a bend.

4. The dual-frequency antenna as claimed in claim 3, wherein the short-circuit path is a metal sheet with one bend, two ends of the short-circuit path are respectively electrically connected with the short-circuit point and the feed point.

5. The dual-frequency antenna as claimed in claim 4, wherein the connection path is a metal sheet with two bends, two ends of the connection path are respectively electrically connected with the first connecting point and the second connecting point.

6. The dual-frequency antenna as claimed in claim 5, wherein the connection path is an inverse U-shaped metal sheet.

7. The dual-frequency antenna as claimed in claim 2, wherein the radiation path is a metal sheet with two bends, the radiation path has a similar L-shaped structure, and a free end of a short edge of the similar L-shaped structure is bent and extended to form the feed point.

8. The dual-frequency antenna as claimed in claim 7, wherein the short-circuit path is a metal sheet with one bend, two ends of the short-circuit path are respectively electrically connected with the short-circuit point and the feed point.

9. The dual-frequency antenna as claimed in claim 4, wherein is a metal sheet without a bend, two ends of the connection path are respectively electrically connected with the first connecting point and the second connecting point, and the connection path is located between the radiation path and the short-circuit path.

10. The dual-frequency antenna as claimed in claim 1, wherein the substrate is a solid substrate or an air substrate.

11. The dual-frequency antenna as claimed in claim 2, wherein the radiation path is a metal sheet with two bends and extended parallel to one side of the ground plane, then bent inclinedly and extended for a length, and further, a free end of the radiation path is bent inclinedly and extended to form the feed point.

12. The dual-frequency antenna as claimed in claim 11, wherein the short-circuit path is a metal sheet which is formed inclinedly and has one bend, and two ends of the bent metal sheet are respectively electrically connected with the short-circuit point and the feed point.

13. The dual-frequency antenna as claimed in claim 12, wherein the connection path is a metal sheet without a bend, two ends of the metal sheet are respectively electrically connected with the first connecting point and the second connecting point, and the connection path is disposed inclinedly between the radiation path and the short-circuit path.
